(19) United States
(12) Patent Application Publication
(10) Pub. No.: US 2023/0131911 A1
(43) Pub. Date: Apr. 27, 2023

(54) TOP DRIVE VALVE STOP ASSEMBLY

(71) Applicant: Justin HACKLEMAN, ODESSA, TX (US)

(72) Inventor: Justin HACKLEMAN, ODESSA, TX (US)

(21) Appl. No.: 17/507,209

(22) Filed: Oct. 21, 2021

(51) Int. Cl. F16K 1/36; E21B 21/10

(52) U.S. Cl. CPC F16K 1/36; E21B 21/106; F16K 31/52408

(57) ABSTRACT

A stop assembly includes a top plate and a stem. The top plate is configured to seat onto the stem. The stem is configured to rotate within grooves of the top plate so as to open and close a valve. The stem has a lower surface and an upper surface and includes a mating aperture through the central body extending above the upper surface. It also has a pair of tabs protruding from the upper surface adjacent the mating aperture. The mating surface and the pair of tabs divide the upper surface to form opposing ledges partially around a perimeter of the central body. The top plate has a central aperture and a pair of opposing grooves that create a pair of stops. The stops are configured to rest adjacent the opposing ledges, such that rotation of the stem contacts the pair of stops against the pair of tabs.

### BACKGROUND OF THE INVENTION

### 1. Field of the Invention

The present application relates to an oil and gas can rig valve, and more particularly to a stem and plate for use in the valve.

### 2. Description of Related Art

Drilling uses “mud” that goes down the internal diameter of the drill pipe and washes the cutting back up on the outside of the drill pipe. A top drive is the motor used to rotate the drill pipe in the hole. There is a ball valve that is used to turn off and on the mud. This valve is installed just below the top drive. Some companies manufacture their own top drive and also sometimes the contraption that opens and closes the valve mechanically with hydraulics. These actuators have the capabilities of using shims in order to time the ball valve perfectly open and perfectly closed. Most companies do not take the time to align.

In operation the valve is open and closed by rotating a stem. The stem includes a mating aperture. Traditionally these mating apertures are minimized or shortened along its sides wherein the full perimeter of the mating aperture is not maintained. For example, wherein the mating aperture is shaped in a hex configuration, two or more of the sides of the hex are shortened to be only half as long as the others. This has obvious disadvantages when a tool is inserted into the mating aperture. Increased wear and potential for slippage is increased.

A keyed tool is inserted into a mating aperture and is rotated. This action rotates the stem between an open and closed state which in turns off or on the flow of mud. A stop plate is used to locate one or more stops to regulate the rotational movement of the stem. Customarily these stops are spaced away from the center. This causes rotational torque loads to be increased at the outer portions of the stop. Additionally, the size of the stops are small such that they typically fail to extend the full depth of the plate. Furthermore, some only locate one stop for opening and one stop for closing of the valve.

Although strides have been made, shortcomings remain. Current valves and plate designs fail to provide the longevity and safety required in the industry. It is desired that an assembly be provided that includes full length mating aperture sides, multiple stops for both opening and closing the valves, and full depth stops.

### BRIEF SUMMARY OF THE INVENTION

It is an object of the present application to provide a stronger and more capable top drive valve assembly for use in the oil and gas industry. The assembly will include a stem and top plate configured to rotate relative to one another. A valve is in communication with the stem. The stops on the top plate are configured to be full depth. The assembly will use a plurality of stops for both opening and closing. Additionally, the mating aperture will remain full length around its perimeter.

Another object of the present application is that the top plate includes counter sunk fasteners. These fasteners are secured with snap rings that are inserted into grooves in the recess of the top plate.

Ultimately the invention may take many embodiments. In these ways, the present invention overcomes the disadvantages inherent in the prior art. The more important features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one embodiment of the present invention in detail, it is to be understood that the embodiments are not limited in its application to the details of construction and the arrangements of the components set forth in the following description or illustrated in the drawings. The embodiments are capable of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. It is important, therefore, that the claims be regarded as including such equivalent constructions insofar as they do not depart from the spirit and scope of the present application.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a perspective view of a side view of a valve and stop assembly according to an embodiment of the present application.

FIG. 2 is a perspective view of the stop assembly of FIG. 1 removed from the valve.

FIG. 3 is a partially exploded view of the stop assembly of FIG. 2 showing a stem and a top plate separated.

While the embodiments and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE INVENTION

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

The embodiments and method will be understood, both as to its structure and operation, from the accompanying drawings, taken in conjunction with the accompanying description. Several embodiments of the assembly may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

The embodiments and method of the present application is illustrated in the associated drawings. The valve and stop assembly includes a valve having an internal stem coupled to the valve such that operation of the stem, being rotated, either permits or restricts the flow of material through the valve. The stem and top plates are configured to handle increased loads through the inclusion of design features. The assembly includes full depth mating aperture around its full periphery. Additionally included are dual stops for both opening and closing. Furthermore, the stops are full distanced stops from the mating aperture to the perimeter of the top plate. Additional features and functions are illustrated and discussed below.

Referring now to the Figures wherein like reference characters identify corresponding or similar elements in form and function throughout the several views. The following Figures describe embodiments of the present application and its associated features. With reference now to the Figures, embodiments of the present application are herein described. It should be noted that the articles “a”, “an”, and “the”, as used in this specification, include plural referents unless the content clearly dictates otherwise.

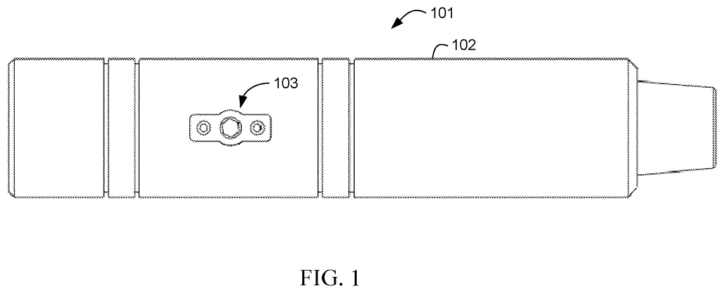

Referring now to FIG. 1 in the drawings, a side view of a valve 101 and stop assembly 103 are illustrated. The valve 101 is used in the drilling process for oil and gas wells and is configured to selectively regulate the flow of working fluid or material through stem pipe during drilling. The stop assembly 103 is seated at least partially within the exterior housing of valve 101. The stop assembly 103 is configured to accept a keyed tool to permit operation of an internal valve in communication with the working fluid. Rotation of the stop assembly 103 actuates that valve body between an open and closed position.

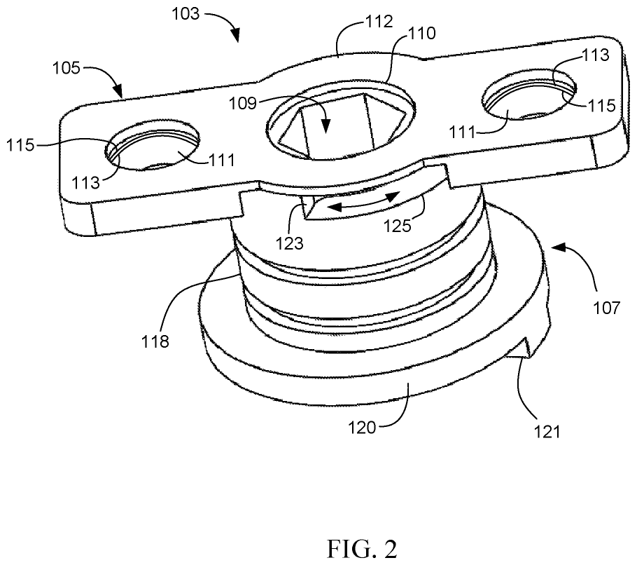

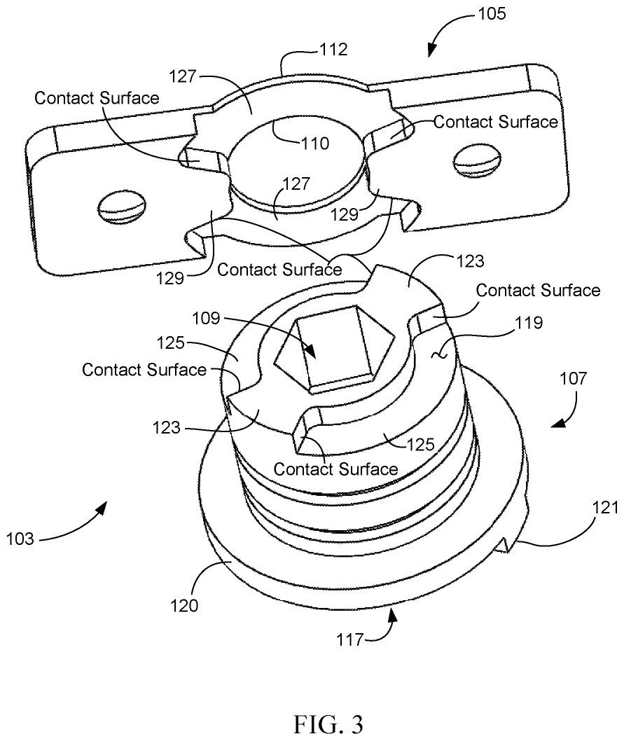

Referring now also to FIGS. 2 and 3 in the drawings, views of the stop assembly 103 are illustrated. Stop assembly 103 includes a top plate 105 and a stem 107. The stem 107 is inserted within valve 101 and is configured to selectively rotate as a method of actuating the valve to regulate flow of the working fluid through valve 101. Top plate 105 is secured to an outer portion of housing 102 and is configured to selectively engage stem 107. Top plate 105 is configured to regulate the amount of rotation of stem 107 through the use of a pair of stops. The stem 107 includes a pair of tabs to engage the stops which coincide with an open and a closed position of the valve.

FIG. 2 illustrates a perspective view of top plate 105 resting on stem 107. An arrow is shown just beneath top plate 105 showing the rotation of stem 107. Stem 107 is rotated by inserting a keyed tool (not shown) into a mating aperture 109 on stem 107. Top plate 105 includes a central aperture 110 concentric to and slightly larger than mating aperture 109. The tool would pass through aperture 110. Top plate 105 is generally rectangular expect for a middle portion 112 that is somewhat flared outward increasing the overall width of the body as a whole. This flaring is sized to cover the diameter of stem 107.

Included on top plate 105 are a pair of recesses 111 located along an upper surface. Within the pair of recesses is a slot 113 for acceptance of a snap ring 115. Fasteners (not shown) are set within the recesses, passing though top plate 105 and securing to housing 102. The fasteners prevent movement of top plate 105. The snap rings 115 secure the fasteners into the pair of recesses 111 so as to prevent backing out.

Stem 107 has a cylindrical body 118 with a lower surface 117 and an upper surface 119. A flange 120 is formed around the lower surface 117 so as to extend outward around the periphery of the cylindrical body. A cam 121 is formed along lower surface and protrudes outward from flange 120. Cam 121 is configured to rotate with body 116 as stem 107 is rotated.

Stem 107 includes a mating aperture 109 that passes internally within body 118. Mating surface 109 extends upward from upper surface 119. Stem 107 also includes a pair of tabs 123 also extending upward from upper surface 119. Ideally the height of the mating surface 109 and pair of tabs 123 are equal above upper surface 119. Tabs 123 and mating aperture 109 are integrated with each other such that they act to divide upper surface 119. Tabs 123 extend from the perimeter of body 118 to mating aperture 109. The portions of upper surface 119 not part of tab 123 and mating aperture 109 appear as opposing ledges 125 on either side of tabs 123. It is important to note that the tabs 123 extend the full depth between aperture 109 and outer perimeter of body 118.

Tabs 123 are configured to seat within a pair of opposing grooves 127 formed along the lower surface of top plate 105. Grooves 127 are formed in middle portion 112 and extend either side of stops 129. Grooves 127 in effect make the thickness of middle portion 112 thinner than the rest of its body. Stops 129 extend from central aperture 110 outward the full depth of grooves 127. As seen in FIG. 2, top plate 105 seats on top of upper surface 119 of stem 107. Tabs 123 are configured to rest within a designated groove 129. Rotation of stem 107 through aperture 109 rotates stem 107 the rotational distance determined by the size of grooves 127.

As stem 107 is configured to regulate the operation of a valve unit. The interaction of tabs 123 with stops 129 are important. There are contact points on either side of each of tabs 123 and each of stops 129. Rotation opens and closes the valve unit. The configuration of the valve unit dictates whether a full counter-clockwise or clockwise rotation opens or closes the valve. Fully rotating stem 107 brings into contact each tab 123 with an adjacent stop 129. When rotated the other way, each tab 123 also contacts an adjacent stop 129. It is important to note that this design permits a dual tab and stop configuration wherein opening and closing of the valve unit brings at least 2 separate stops and tabs into contact.

Also of note is that the tabs 123 extend the full depth/width, from the mating aperture 109 to outer circumference of body 118. Likewise stops 129 extend the full depth/width of grooves 127 from the central aperture 110 outward. This creates large contact surfaces between stops 129 and tabs 123. Contact forces between stops 129 and tabs 123 are minimized by having the larger contact area.

It is also worth noting that mating aperture 109 is raised above upper surface 119 around its entire perimeter. The sides of mating aperture 109 are not trimmed down at selected areas making an uneven top perimeter. Mating aperture 109 has full depth and height around its entire perimeter. This helps to prevent stripping of the keyed tool in the mating aperture 109. It also helps to assist in proper seating of the keyed tool and minimized wear.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A stop assembly, comprising:
a stem having a lower surface and an upper surface, the stem including:
a mating aperture through the central body extending above the upper surface; and
a pair of tabs protruding from the upper surface adjacent the mating aperture;
wherein the mating surface and the pair of tabs dividing the upper surface so as to form opposing ledges partially around a perimeter of the central body; and
a top plate having a central aperture and a pair of opposing grooves, the opposing grooves creating a pair of stops;
wherein the stops are configured to rest adjacent the opposing ledges, such that rotation of the stem contacts the pair of stops against the pair of tabs.

2. The assembly of claim 1, wherein the pair of opposing ledges being formed from the protrusions of the mating aperture and the pair of tabs beyond the upper surface.

3. The assembly of claim 1, wherein the pair of tabs extend from the mating aperture to the perimeter of the central body.

4. The assembly of claim 1, wherein the pair of tabs extend the full depth of the pair of opposing ledges on the upper surface.

5. The assembly of claim 1, wherein the mating aperture and the pair of tabs extend across the diameter of the central body.

6. The assembly of claim 1, wherein the mating aperture extends above the upper surface at the same height around its entire perimeter.

7. The assembly of claim 1, wherein the central aperture is concentric to and larger than the mating aperture.

8. The assembly of claim 1, wherein both of the pair of stops contact at least one of the pair of tabs simultaneously.

9. The assembly of claim 1, wherein the pair of stops extend inward the full depth of the opposing ledges.

10. The assembly of claim 1, further comprising:
a cam extending out from the lower surface.

11. The assembly of claim 1, wherein the top plate includes a pair of recesses along an upper surface.

12. The assembly of claim 11, further comprising:
a snap ring, the snap ring inserted into a slot formed within at least one of the pair of recesses.

13. The assembly of claim 12, further comprising:
a fastener inserted though one of the pair of recesses and secured by the snap ring.

14. A stop assembly, comprising:
a stem having a lower surface and an upper surface, the stem including:
a mating aperture through the central body extending above the upper surface;
a pair of tabs protruding from the upper surface adjacent the mating aperture; and
a cam extending out from the lower surface;
wherein the mating surface and the pair of tabs dividing the upper surface so as to form opposing ledges partially around a perimeter of the central body; and
a top plate having a central aperture and a pair of opposing grooves, the opposing grooves creating a pair of stops;
wherein the stops are configured to rest adjacent the opposing ledges, such that rotation of the stem contacts the pair of stops against the pair of tabs.

15. The assembly of claim 14, wherein the top plate includes a pair of recesses along an upper surface, each recess includes a slot.

16. The assembly of claim 15, further comprising:
a snap ring inserted into the slot, the snap ring to secure fasteners into the pair of recesses.

17. The assembly of claim 14, wherein the pair of tabs extend from the mating aperture to the perimeter of the central body.

18. The assembly of claim 14, wherein the pair of tabs extend the full depth of the pair of opposing ledges on the upper surface.

19. The assembly of claim 14, wherein the mating aperture and the pair of tabs extend across the diameter of the central body.

20. The assembly of claim 14, wherein the mating aperture extends above the upper surface at the same height around its entire perimeter.
